(19) United States
(12) Patent Application Publication
(10) Pub. No.: US 2008/0035548 A1
(43) Pub. Date: Feb. 14, 2008

(54) Multi-functional filtration and ultra-pure water generator

(75) Inventor: Chinbay Fan, Chicago, IL (US)

Correspondence Address: MORRISON & FOERSTER LLP, 755 PAGE MILL RD, PALO ALTO, CA, 94304-1018, US

(73) Assignee: Quos, Inc., Menlo Park, CA (US)

(21) Appl. No.: 11/724,534

(22) Filed: Mar. 14, 2007

Related U.S. Application Data
(63) Continuation-in-part of application No. 11/515,544, filed on Sep. 5, 2006.
Application No. 11/515,544 is a continuation-in-part of application No. 11/497,092, filed on Aug. 1, 2006.

(51) Int. Cl. F02M 37/22; H01M 4/60

(52) U.S. Cl. 210/243; 429/213

(57) ABSTRACT

A water purification system having a porous anode electrode (21) and a porous cathode electrode (20), each of which is made of graphite, at least one metal oxide, and an ion-exchange, cross-linked, polarizable polymer, and optionally comprises microchannels. Disposed between the electrodes is a non-electron conductive, fluid permeable separator element (22), whereby wastewater is able to flow from one electrode to the other electrode. The electrodes and separator may be disposed within a housing (23) having a wastewater inlet opening (24), and exhaust waste outlet opening (26) and a purified water outlet opening (25). In this way, components of the system are easily replaced should the need arise.

### CROSS-REFERENCE TO RELATED APPLICATIONS

This application is a continuation-in-part of U.S. patent application Ser. No. 11/515,544, filed on Sep. 5, 2006, which is a continuation-in-part of U.S. patent application Ser. No. 11/497,092, filed on Aug. 1, 2006, both of which are incorporated by reference herein in their entireties.

### BACKGROUND OF THE INVENTION

1. Field of the Invention

This invention relates to an apparatus for water purification. More particularly, this invention relates to a multi-functional apparatus for water purification having the functionalities of ion-exchange, carbon adsorption, electrochemical ionic adsorption and desorption, and microfiltration. The apparatus is capable of removing ionized and non-ionized organic compounds, inorganic ions, particulates and bacteria from wastewater streams in a single unit to produce potable water. Porous carbon-based electrodes function as impurities filters to remove particulate matter, such as ash, sand and high molecular weight compounds, as electrodes to concentrate and remove ionic species, and as adsorbents to remove organic materials and bacteria from the wastewater stream.

2. Description of Related Art

Known water purification methods include distillation, ion-exchange, carbon adsorption, filtration, ultrafiltration, reverse osmosis, electrodeionization, capacitive deionization, ultraviolet radiation, and combinations thereof. However, each of these methods has shortcomings. Distillation cannot remove some volatile organics and it consumes large amounts of energy. In ion-exchange processes, water is percolated through bead-like spherical resin materials. However, the resin materials need to be regenerated and changed frequently. In addition, this method does not effectively remove particles, pyrogens, or bacteria. Carbon adsorption processes can remove dissolved organics and chlorine with long life and high capacity; however, fine carbon particles are generated during the process due to corrosion. Micropore membrane filtration, a high cost process, removes all particles and microorganisms greater than the pore size of the membrane; however, it cannot remove dissolved inorganics, pyrogens or colloids. The ultrafilter is a tough, thin, selectively permeable membrane that retains most macromolecules above a certain size, including colloids, microorganisms, and pyrogens; however, it will not remove dissolved organics. Reverse osmosis is the most economical method for removing 90 to 99% of all contaminants. Reverse osmosis membranes are capable of rejecting all particles, bacteria, and organics; however, the flow rate and productivity are low. Electrodeionization, which is the subject matter of U.S. Pat. No. 6,824,662 B2 to Liang et al., is a combination of electrodialysis and ion-exchange, resulting in a process which effectively deionizes water while the ion-exchange resins are continuously regenerated by the electric current; however, this method requires pre-purification to remove powders and ash materials. Ultraviolet radiation cannot remove ionized inorganics.

FIG. 1 is a diagram showing a capacitive deionization process with carbon aerogel electrodes. In this process, salt water is introduced into the cell, the negative electrode (anode) 11 adsorbs positive ions 13 and the positive electrode (cathode) 12 adsorbs negative ions 14. When the cell is charged, pure water is obtained, and when the cell is discharged, concentrated salt water is removed. To achieve this result, pulsed electrical power at voltages from 1.2V to 0V is used for different time periods depending on the concentration of the salt water and the activity of the activated carbon. The more accessible surface area the electrode has, the more ions that can be stored. The main problem with this method is that the electrosorption capacity (salt removal) decreases with cycle life. Most of the capacity loss can be recovered by periodic reversing of the electrode polarization. However, the interface between the active carbon and the aerogel diminishes, reducing the actual electrode active area. Ultimately, the carbon particles will no longer contact each other and will leach out. In addition, capacitive deionization requires aggressive pre-filtration and cannot remove non-ionic species.

An electrically regenerable electrochemical cell for capacitive deionization and electrochemical purification and regeneration of electrodes is taught by U.S. Pat. No. 6,309,532 B1 to Tran et al. The cell includes two end plates, one at each end of the cell, and a plurality of generally identical double-sided intermediate electrodes that are equidistantly separated from each other between the two end plates. The electrodes comprise a Ti substrate coated with carbon gel (carbon aerogel). As the electrolyte enters the cell, it flows through a continuous serpentine channel formed by the electrodes, substantially parallel to the electrodes. By polarizing the cell, ions are removed from the electrolyte and are held in electric double layers formed at the carbon aerogel surfaces of the electrodes. The cell is regenerated electrically to desorb the previously removed ions. However, by virtue of the serpentine flow arrangement between the electrode plates, the useful area for the electrodes is limited to the electrode surface.

There is a need for an improved water filtration device which is capable of removing particulate material, inorganic ions, ionic and non-ionic organic substances, and/or bacteria from water containing such substances.

### SUMMARY OF THE INVENTION

It is one object of this invention to provide a method and apparatus for wastewater purification which addresses the shortcomings of the known methods and systems for wastewater purification.

It is one object of this invention to provide an apparatus for wastewater purification which removes ionized and non-ionized organic materials, inorganic ions, particulates and bacteria in a single unit process.

These and other objects of this invention are addressed in one aspect by an apparatus for water purification comprising a multi-functional, porous, carbon-based composite electrode comprising an ion-exchange resin as a binder, carbon black and/or graphite as active adsorbents, and metal oxides as adsorbent promoters. The porous carbon-based plates may be molded by mixing metal oxides, carbon and/or graphite powders, polymer resin and a bubbling agent, such as ammonium bicarbonate. The resins are cross-linked for stability and the porosity of the resulting electrode plate is more than about 50%, for example, about 50% to about 80%, by volume.

In another aspect, electrodes for use in water purification are provided, which electrodes function as electrical field suppliers, ion-exchange resin holders, and colloid powders filters. In operation, the positive electrode absorbs negative ions while the negative electrode adsorbs positive ions.

In another aspect, an apparatus for water purification is provided comprising a porous anode electrode, a porous cathode electrode, and an electrically non-conductive, fluid permeable separator element disposed between the anode electrode and the cathode electrode. Each of the electrodes comprises graphite, at least one metal oxide, and an ion-exchange, cross-linked, polarizable polymer. The electrodes and separator element are preferably disposed in an electrically nonconductive housing having a wastewater inlet opening and a purified water outlet opening and may be used in a single cell configuration or in a series configuration with additional cell units. The apparatus of this invention acts as a filter, organic and bacteria adsorbent and also functions as a desalination system. The apparatus may also be used to concentrate soluble salts from a dilute aqueous solution. One application for the water purification system of this invention is marine water desalination.

### BRIEF DESCRIPTION OF THE DRAWINGS

FIG. 1 depicts a conventional capacitive deionization method.

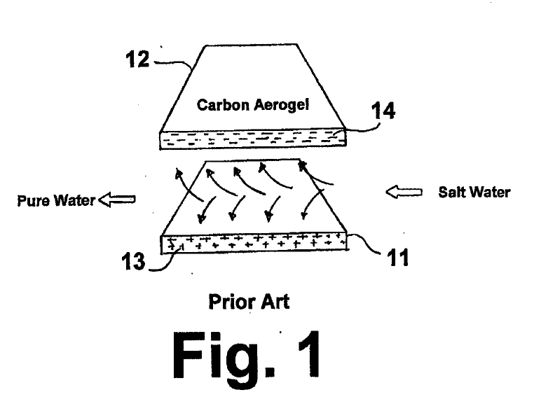

FIG. 2 is a schematic diagram showing a single cell compartment for wastewater treatment in accordance with one embodiment of this invention.

FIG. 3 is a schematic diagram showing a multi-cell compartment for wastewater treatment in accordance with one embodiment of this invention.

FIG. 4 is a schematic diagram showing a two-stage water purification system in accordance with one embodiment of this invention.

FIG. 5 schematically depicts microchannels in the porous electrode, as described in Example 5.

FIG. 6A is a schematic diagram of a water purification system in accordance with one embodiment of this invention. FIG. 6B schematically depicts voltage changes with electrode couples in series, as shown in the system depicted in FIG. 6A.

FIG. 7 schematically depicts a water purification system in which solenoid valves are used for discharge of particulate impurities from the water stream.

FIG. 8 schematically depicts assembly of an electrode in the housing of a water purification device as described herein.

FIG. 9 shows water permeability as a function of water pressure in a pressure-driven water filtration device as described in Example 6.

FIG. 10 shows water conductivity as a function of time when ferric nitrate is filtered in a pressure-driven water filtration device as described in Example 6.

### DETAILED DESCRIPTION

The invention provides methods and systems for water purification. Methods and systems described herein are capable of purifying most water streams requiring purification, including but not limited to industrial wastewater, gas and oil field wastewater, and coal mine wastewater, and is well-suited for desalination of salt water. Methods and systems described herein may also be used for purification of drinking water, for example, removal of ions such as sodium, magnesium, calcium zinc, and/or lead cations, and/or chloride, sulfate, and/or bromide anions from tap water. The system incorporates electrochemical deionization, microfiltration, carbon adsorption, and ion exchange features to remove organic materials, inorganic materials, bacteria and solid particles. The system is compact, energy efficient, and cost efficient to produce and operate.

### System and Method for Water Purification

The invention provides a water purification system comprising at least one pair of porous carbon-based electrodes, i.e., a porous anode electrode and a porous cathode electrode, with a non-conductive, fluid permeable separator between the two electrodes to prevent excess current flow between the electrodes. The porous electrodes comprise graphite for conductivity, at least one metal oxide, which increases water adsorption by the electrode, and at least one ion-exchange, cross-linked, polarizable polymer, which binds the components of the electrode together and provides ion-exchange sites for binding ionic compounds in the water stream. In some embodiments, the electrodes also comprise carbon black, carbon fibers, and/or silica. The porous carbon-based electrodes filter particulate matter that is too large to traverse the pores, electrochemically concentrate and sequester ionic species such as inorganic, e.g., metal, ions and ionized organic compounds, and adsorb non-ionized organic materials and bacteria from a water stream. The ion-exchange polymer component of the electrode also binds ionized compounds in the water stream.

In some embodiments, the electrodes contain microchannels through the electrode, covered by a thin layer membrane of the cross-linked polymer at the ends of the microchannels that open to the surface of the electrode or in the interior of the channels. In one embodiment, the electrode comprises front and back surfaces, the microchannels comprise openings at the front and back electrode surfaces, and the electrode comprises a thin layer polymeric membrane covering the microchannel openings on the front and back surfaces of the electrode. The thin layer polymeric membranes act as microfilters, preventing particulate matter that is larger than the microchannels from flowing through the electrode.

A water purification system of the invention includes a non-conductive housing with at least one inlet to introduce a water stream to be purified into the housing and an outlet through which purified water exits the housing. The water stream flows from the inlet to the outlet through the porous electrodes and separator. The housing may also include at least one waste outlet, through which particulate materials that is too large to traverse the pores of the electrodes may exit.

In some embodiments, the water purification system comprises a plurality of unit cells, each of which contains a pair of porous anode and cathode electrodes as described herein with a nonconductive, water permeable separator between the two electrodes. The unit cells may be arranged in series such that a water stream to be purified traverses the cells sequentially, with water of increasing purity being produced as the water stream proceeds through the series of cells. The inlet for such a water purification system may be located upstream from the first electrode through which the water stream travels in the first unit cell, and the outlet for purified water may be located downstream from the second electrode through which the water stream travels in the last unit cell. The water stream travels from the inlet to the outlet through at least one unit cell (i.e., at least one pair of porous electrodes and the separator between the electrodes) of the water purification system. In one embodiment, the water stream flows through all of the unit cells of the water purification system. In various embodiments, the water purification system includes 2, 3, 4, 5, 7, 8, 9, 10, or more unit cells. In some embodiments, the water purification system includes 2 to 4 unit cells.

In some embodiments, a water purification system as described herein is operated under atmospheric pressure conditions. In other embodiments, the water purification system is operated at a pressure that is greater than atmospheric pressure. In some embodiments, the water purification system is operated at about 1 to about 40 pounds per square inch. In one embodiment, the water purification system is operated at about 40 pounds per square inch.

The invention provides a method for water purification, including introducing a water stream to be purified into a water purification system as described herein. The water purification system includes a housing having an inlet, an outlet and a flowing water stream. The water stream flows from the inlet to the outlet through at least one unit cell that includes a porous anode electrode, a nonconductive fluid permeable separator, and a cathode electrode. Each porous electrode contains graphite, for example, exfoliated graphite, at least one metal oxide, and at least one cross-linked polymer with ion exchange groups. The water stream flows through the electrodes and the separator from the anode to the cathode, or from the cathode to the anode. Particulate matter that is too large to traverse the pores of the electrode may exit the housing through a waste outlet. Ionic, organic, and/or bacterial components of the water stream are retained on the electrodes as the water stream flows through the water purification system, and water exiting the system through the outlet contains reduced amounts of these components than the water stream entering through the inlet. In some embodiments, water is purified through a plurality of unit cells arranged in series such that water flows sequentially through the unit cells and the water stream exiting each unit cell contains a reduced amount of ionic, organic, and/or bacterial contamination than the water stream exiting the previous unit cell in the series.

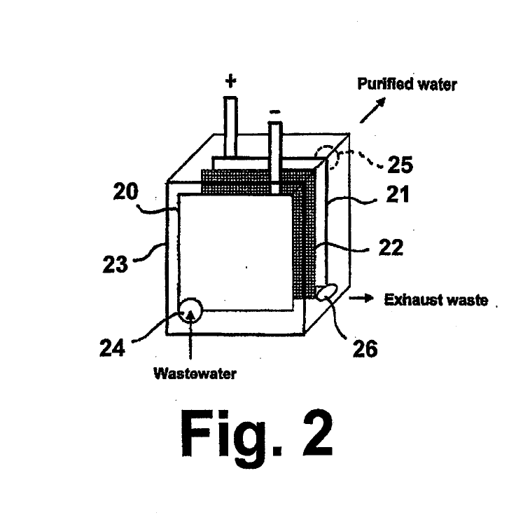

An example of a water purification system in a single cell arrangement in accordance with one embodiment of this invention is shown schematically in FIG. 2. The system comprises a porous cathode electrode 20, a porous anode electrode 21 and an electrically nonconductive, fluid permeable separator element 22 disposed between the anode electrode and the cathode electrode to prevent shorting. Fluid permeable separator element 22 in accordance with one embodiment of this invention is a perforated separator, such as perforated polyethylene, having an open area of at least about 60% enabling flow through of the water stream to be purified. In accordance with one embodiment of this invention, the electrodes and the separator element are disposed within an electrically non-conductive, e.g., plastic, housing 23 which is provided with an inlet opening 24 for introducing the water stream to be purified into the cell for processing, an exhaust waste outlet opening 26 through which solid materials separated out of the water stream may be removed, and a purified water outlet opening 25 through which purified water may be removed. Thus, in the embodiment shown in FIG. 2, a water stream to be purified is introduced into the housing through inlet opening 24 disposed near the bottom of housing 23 enabling particles and other solid matter in the water stream filtered out by anode electrode 20 to fall to the bottom of the housing for removal through exhaust waste outlet opening 26. One of the benefits of this arrangement is the easy removal of the electrodes for replacement should the need arise. Although the embodiment of the water purification system depicted in FIG. 2 shows water flowing from anode to cathode, in other embodiments, water flow may be from cathode to anode.

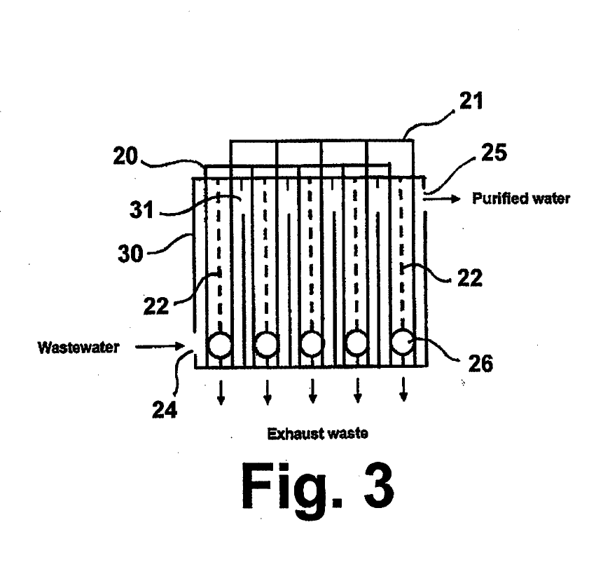

FIG. 3 is a schematic diagram of an example of a water purification system in accordance with one embodiment of this invention comprising a plurality of cell units (i.e., at least two cell units each comprising a pair of porous electrodes with a separator between the electrodes) disposed within a non-conductive housing 30 and arranged for sequential flow of a water stream to be purified through the cells. The water stream is introduced through inlet opening 24 disposed near the bottom of housing 30 into the first cell unit and rises within the cell unit. Solid materials within the wastewater fall to the bottom of the housing for removal through exhaust waste outlet opening 26. Upon rising to the top of the first cell unit, the water stream, which is now substantially devoid of solid materials passes through intercell fluid opening 31 into the next cell unit for further treatment. The water stream, which becomes successively more purified as it passes through each cell unit, is ultimately passed through purified water outlet opening 25 as substantially pure water.

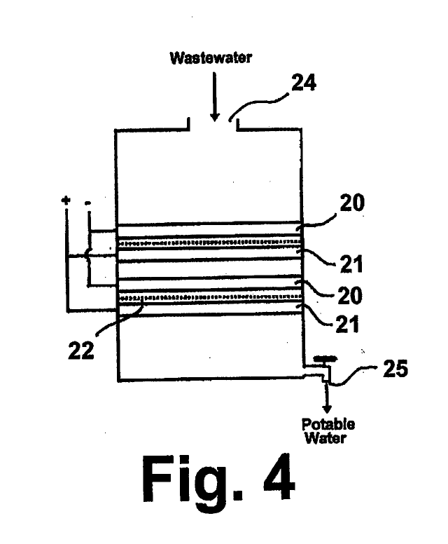

FIG. 4 shows a schematic diagram of a water purification system in accordance with yet another embodiment of this invention having two stages for producing potable water. In this embodiment, a water stream to be purified is introduced through inlet opening 24 at the top of a housing and filters through the two stages of cell units, becoming potable water in the process.

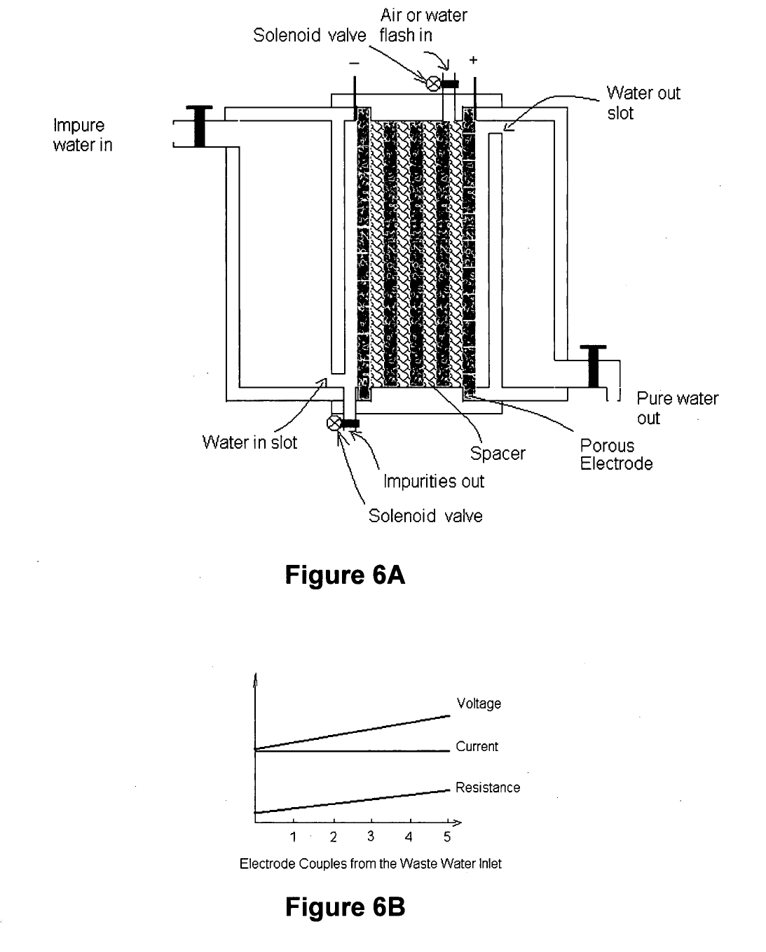

FIG. 6A shows a schematic diagram of a water purification system in accordance with another embodiment of this invention. Water to be purified enters the water purification system through an inlet opening at the top of the device and flows through a slot at the bottom of the device to contact the porous electrodes. Several electrodes are arranged in series, with a non-conductive water permeable spacer separating the electrodes from each other. End electrodes are connected to positive and negative power supplies. Water flows through the bottom slot, into an open area upstream from and parallel to the series of electrodes, flows through the series of electrodes, flows into an open area downstream from and parallel to the series of electrodes, flows through a slot at the top of the device and exits the device through an outlet opening at the bottom of the water purification system. As depicted in FIG. 6B, the current for such a device remains constant throughout the series of electrodes, but the voltage and water resistance increase from inlet to outlet.

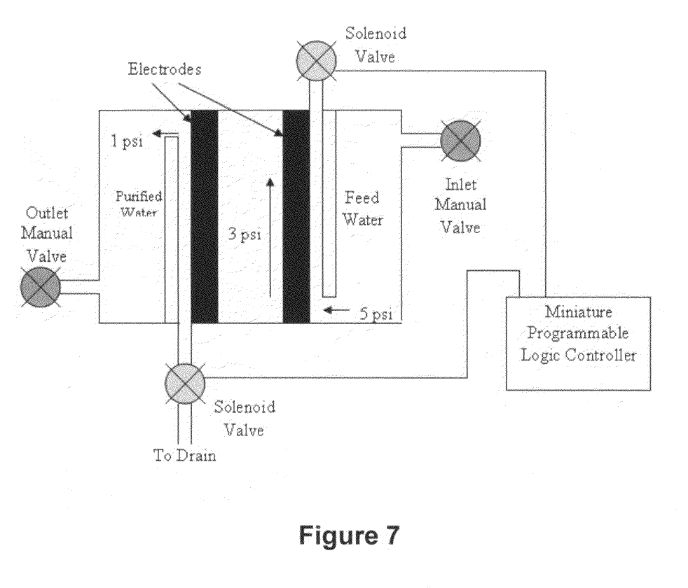

Particulate matter may be trapped at the inlet slot and removed by discharge through a waste outlet close to the inlet slot. The purge may be top-down by air or water through the porous electrodes with the electric current turned off, and optionally may be controlled through a solenoid valve, as depicted in FIG. 6A. For example, as depicted in FIG. 7, if the water flow in the water purification system is at a pressure of 5 psi, the water pressure drops through the electrodes as shown. If the water inlet and outlet valves are closed, and the discharge valves (e.g., solenoid valves) are opened, impurities are released due to the pressure inside the device. Another possible way to release impurities is by pumping air or water from the top to the bottom of the device.

### Electrodes

The electrodes, which provide particle filtration, ionic species concentration and removal, and organic material and bacteria removal, are carbon-based porous structures. In accordance with the embodiments shown in the drawings, the electrodes are porous planar structures, i.e., plates, and the separator element is a perforated plate. However, any other configurations of electrodes and separator elements which provides the desired relationship between the electrodes and the separator element, such as tubular or rolled structures, may also be employed, and it is to be understood that such configurations are also considered to be within the scope of the invention claimed herein.

There are three basic requirements for an electrode for the water purification system of this invention—porosity, electrical conductivity, and mechanical strength. Accordingly, the electrodes are carbon-based porous structures comprising graphite for conductivity, at least one metal oxide, for increasing water adsorption by the electrode, and an ion-exchange, cross-linked, polarizable polymer for binding the components of the electrode together, and for providing mechanical strength to the electrode. The ion-exchange polymer component also provides ion exchangeable groups on the surface of the electrode for binding ionic components of the water stream. In accordance with one embodiment of this invention, electrical conductivity of the electrode may be enhanced by the addition of carbon black. In some embodiments, the electrode may comprise carbon fibers, which may increase the mechanical strength of the electrode and/or silica, which may increase powder mixing uniformity and electrode wettability. In embodiments in which carbon fibers are added, this component is typically included at a weight percentage of about 5 to about 30 percent. In embodiments in which silica is added, this component is typically included at a weight percentage of less than about 5 percent.

In some embodiments, electrodes of the invention comprise exfoliated graphite. Exfoliated graphite is the product of very rapid heating (or flash heating) of graphite intercalation compounds, such as graphite hydrogen sulfate, of relatively large particle diameter (flakes). Vaporization of intercalated substances force the graphite layers apart resulting in an accordion-like shape with an apparent volume typically hundreds of times that of the original graphite flakes. In accordance with one embodiment of this invention, a porous electrode as described herein comprises exfoliated graphite in the form of particles less than about 50μ in size. Exfoliated graphite may have a surface area as high as 700 m²/g.

In one embodiment, exfoliation of graphite is effected using graphite power (e.g., Superior Graphite Corporation, Chicago) mixed with an HNO₃/H₂SO₄ solution (e.g., 1:9 HNO₃:H₂SO₄ v/v). For example, 80 g of graphite power may be mixed with an HNO₃/H₂SO₄ solution, and then heated in a 900 to 1000° C. furnace for 3 minutes.

Exfoliated graphite has C═O and C—OH groups on its surface. The C═O and C—OH groups are available for cross-linking with a polymer binder, which increases the electrode's mechanical strength and reduces carbon corrosion in water. The cross-links also trap fine carbon black particles in electrodes that contain carbon black, which reduces carbon black corrosion.

In addition to graphite and at least one metal oxide, the electrodes of this invention comprise at least one ion-exchange component, which, in addition to providing ion-exchange sites on the electrode, may also be used to bind the components of the electrodes into a cohesive structure. In accordance with one embodiment of this invention, the ion-exchange component is a cross-linked, polarizable polymer. Cross-linking of the polarizable polymer is required to avoid dissolution of the polymer in the water stream being purified. Suitable polymers for use in the electrodes described herein include are cross-linkable and include ion exchange sites, e.g., polymers comprising —NH, —OH, —C═O, and/or —COOH groups. Suitable ion-exchange, polarizable polymers include, but are not limited to, polyurethane, polyacrylic acid, sulfonated polystyrene, poly(vinyl alcohol) (PVA), poly(ethylene vinyl alcohol) (PEVA), polyethylene imine (PEI), and combinations thereof. Suitable agents for cross-linking of the polarizable polymers include glyoxal, ketones, such as acetone, aldehydes, such as formaldehyde and glutaraldehyde, methylene amine, amines, imines, amides, and combinations thereof.

The electrodes of this invention have hydrophilic properties and, as previously indicated, at least one metal oxide is employed in the electrode for the purpose of increasing water adsorption. The metal oxide(s) contributes to hydrophilicity of the electrode. Any metal oxide that is stable in water may be utilized. Examples of suitable metal oxides include TiO₂, Al₂O₃, and mixtures thereof.

It will be appreciated that, depending upon the composition of the water stream being treated, impurities such as oily tars and high organic species may collect on the electrode. Such impurities may be removed by periodic back-flashing of the electrode, as described above. To enhance this process, it is required that, in addition to hydrophilicity, the electrodes of this invention also possess hydrophobic properties. Ions are surrounded by water in aqueous medium. Hydrophobic materials help to expel water, thus expelling ionic impurities. The balance between hydrophilicity and hydrophobicity of the electrode may be controlled, in accordance with one embodiment of this invention, by the appropriate selection of polarizable polymer and cross-linking agent. For example, poly(vinyl alcohol) (PVA) has fewer —CH₂ groups than poly(ethylene vinyl alcohol) (PEVA). In PEVA, the ethylene group provides hydrophobicity. Certain cross-linking agents, such as formaldehyde, have fewer —CH₂ groups than glutaraldehyde and glyoxal. As the number of —CH₂ groups increases, hydrophobicity increases and hydrophilicity decreases. It has been found that compositions with one (1) to five (5) —CH₂ groups provide a desirable balance between hydrophilicity and hydrophobicity of the electrode. In some embodiments, the electrode contains a hydrophobic content of about 20% to about 50%. In some embodiments, the hydrophilicity is greater than about 60% and the hydrophobicity is less than about 40%. In accordance with one preferred embodiment of this invention, the electrode is provided with a hydrophobicity of up to about 50%. In some embodiments, electrodes comprise at least one hydrophobic group, for example, at least one C—C group, CH—CH group, or CH₂—CH₂ group in the polymer.

In one embodiment, an electrode as described herein comprises a current collector embedded within or contacting the edges of the electrode. The current collector may comprise a metal gauze or sheet, such as, for example, stainless steel, nickel, or titanium.

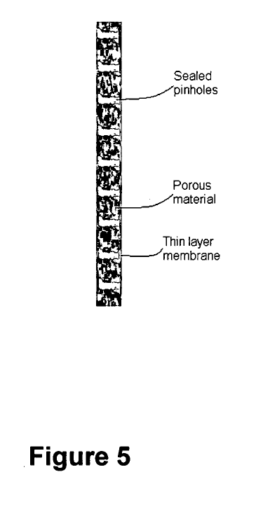

In some embodiments, porous electrodes as described herein comprise microchannels. In some embodiments, the microchannels comprise diameters of about 0.3 to about 0.2 cm with a distance of about 0.5 cm between microchannels. A microchannel may be covered with a water permeable polymeric membrane at each end opening to the surface of the electrode (see, for example, FIG. 5) and/or in the interior of the microchannel. Microchannels increase water permeability and surface area of the electrode available for ion adsorption.

### Electrode Fabrication

In general, the electrodes of this invention may be produced by mixing metal oxide and carbon or exfoliated graphite powders with a polymer resin (polymer solution containing cross-linking agent). and a bubbler, such as ammonium bicarbonate or sodium bicarbonate, and molding (e.g., casting) the mixture at atmospheric pressure and room temperature or an elevated temperature. The amount of ammonium bicarbonate or other bubbler employed depends on the desired porosity of the water permeable electrode. Typically, the electrode contains about 40% to about 80% porosity, depending on the desired balance of conductivity and mechanical strength. It has been found that a mixture comprising about 50-60 wt % graphite powders, about 5-20 wt % carbon black, about 7 wt % polymer resin and up to about 10 wt % ammonium bicarbonate molded at room temperature or an elevated temperature, for example, 200° C., produces a suitable electrode. The polymer is cross-linked after evaporation of solvent.

In one embodiment, an electrode produced as described herein is treated in a hot water bath at about 50 to about 90° C. to remove solvent residue and cross-linked catalyst.

In some embodiments, microchannels are introduced into an electrode of the invention during fabrication. In one embodiment, a casted electrode sheet comprising exfoliated graphite, metal oxide, polymeric binder (e.g., PEVA, PVA, or PEI), and/or other materials such as carbon black, silica, and/or carbon fibers, is allowed to dry at room temperature. Before the sheet is completely dry, small holes are introduced through the entire thickness of the sheet, for example, with pins or laser drills. Liquid polymer covers the ends of the pinholes at the front and back surfaces of the electrode sheet, and then dries, forming a thin water permeable membrane covering the ends of each microchannel. In some embodiments, microchannels with comprise diameters from about 0.1 mm to about 1 mm. In some embodiment, microchannels are spaced about 2 to about 10 mm apart. In one embodiment, microchannels are spaced about 5 mm apart.

### Fluid Permeable Separator

The water purification system as described herein contains an electrically nonconductive, fluid permeable separator situated between the porous anode cathode electrodes to prevent a shortcircuit during operation of the device. In one embodiment, the fluid permeable separator element is a non-electron conductive material, such as commercially available perforated plastic sheet, for example perforated polyethylene, glass fiber paper, other non-electron conductive fiber paper, woven cloth, water permeable anion conductive membrane, or water permeable cation conductive membrane, such as polyamide, polyvinyl alcohol, or polyethylene imine, having an open area of about 40% to about 80%, about 50% to about 70%, or about 60%, enabling flow through of the water stream to be purified.

### Housing

The water purification system described herein contains an electrically nonconductive housing having an inlet opening through which water to be purified is introduced into the water purification system, and an outlet opening through which purified water exits the system.

The housing is composed of an electrically non-conductive material such as plexiglass, polycarbonate, or polyurethane, which are injection moldable. The housing contains an inlet for introducing the water stream to be purified into the system for processing and a purified water outlet through which purified water may be removed. In some embodiments, the housing also contains an exhaust waste outlet opening through which solid materials separated out of the water stream may be removed. The inlet opening and the optional exhaust waste outlet are located upstream from the first porous electrode through which the water stream flows, and the purified water outlet opening is located downstream from the last electrode through which the water stream flows. In some embodiments, the inlet opening is located near the bottom of the housing to facilitate removal of particulate and other solid matter in the water stream too large to traverse the pores of the electrodes through an exhaust outlet at the bottom of the housing. In some embodiments, the purified water outlet is located at the top of the housing downstream from the last electrode through which the water stream flows.

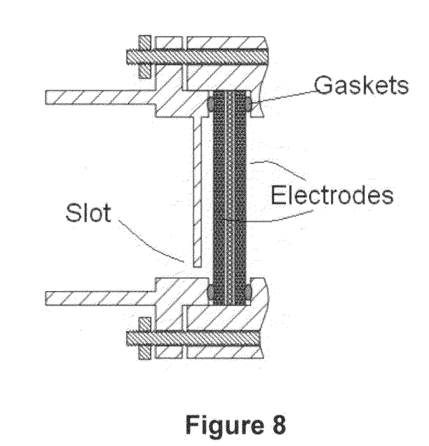

The electrodes may be held in place in the housing with gaskets and may be sealed at their top and bottom edges with liquid polyurethane or another insulator, as shown schematically in FIG. 8.

### Regeneration of Water Purification System

The system may be regenerated by backflashing from the outlet to the inlet under a pressure of about 1 to about 10 psi. The backflash may employ pressurized air, clean water, filtered salt water with a lower concentration of salt than the concentrated waste, or the internal pressure of the device. In a device that operates under pressure, shown schematically in FIG. 7, frequent release of waste through a waste is desirable for removal of concentrated impurities. Water may be used to dilute and remove the concentrated waste.

The following examples are intended to illustrate but not limit the invention.

### EXAMPLE 1

### Production of Exfoliated Graphite

Exfoliated graphite was produced by mixing concentrated sulfuric acid and graphite powders. The mixture was heated in an oven at 600° to 1000° C. The resulting expanded graphite includes C═O and C—OH bonds on the graphite particles, which crosslink with poly(ethylene vinyl alcohol) and glutaraldehyde. The resulting graphite powders are stable in the porous plate and can not wash out during the wastewater treatment process.

### EXAMPLE 2

### Production of Porous Graphite Electrode

9 grams of exfoliated graphite powders were mixed with 10 grams of water and 10 grams of 10 wt % polyvinyl alcohol), forming a first mixture. 10 grams of water were mixed with 2 grams of 50 wt % glutaraldehyde and 0.5 ml HCl (35 wt %), forming a second mixture. The two mixtures were mixed thoroughly and the resulting mixture was cast to produce a 1/16″ thick sheet which was then heat treated at 100° C. Water boiling from the plate generated bubbles, making the plate porous. Because glutaraldehyde binds with poly(vinyl alcohol) in an irreversible fashion, the resulting cross-linked polymer was entirely insoluble, even in hot water. In some experiments, PEVA was used as a binder to increase the electrode strength. The solvent for PEVA was 1:1 volume ratio of 1-propanol and water.

Table 1 shows a comparison of surface resistance between the electrode produced in accordance with this example and other electrode materials.

TABLE 1
Surface Resistance Comparison

| Material | Surface Resistance (Ω) |
|---|---|
| Gold-plated copper | 0.098 |
| Dense Composite Graphite | 0.120 |
| Porous Graphite Sheet | 95 |

### EXAMPLE 3

### Variation of Electrode Porosity by Using Different Bubble Agents

Two graphite-based porous electrodes were produced using different bubble agents. 8 grams of exfoliated graphite powder and 1 gram of bubble agent (ammonium bicarbonate or sodium bicarbonate) were mixed with 10 grams of water and 10 grams of 10 wt % polyvinyl alcohol, forming a first mixture. 10 grams of water were mixed with 2 grams of 50 wt % glutaraldehyde and 1.5 ml HCl (35 wt %), forming a second mixture. The two mixtures were mixed thoroughly and the resulting mixture was cast to produce a 1/16 in thick sheet. The sheet was cured at room temperature. Since glutaraldehyde binds with polyvinyl alcohol in an irreversible fashion, the resulting cross-linked polymer was insoluble, even in hot water.

Electrodes produced with or without bubble agent were produced as described in Example 2 and tested in a gravity-driven device. An electrode produced with no bubble agent had low water permeability (<1 ml/min), and the electrode produced with bubble agent exhibited great improvement in permeability (>20 ml/min). However, the tensile strength of electrodes produced with bubble agents was reduced approximately 20%.

### EXAMPLE 4

### Optimization of Porous Graphite-Based Electrode Composition

Fourteen porous graphite-based electrodes with different compositions were produced as described in Example 2 using a matrix optimization method. The compositions of these electrodes are shown in Table 2.

TABLE 2
Electrode Compositions

| | | | | | | | | 1:1 | | |
|---|---|---|---|---|---|---|---|---|---|---|
| | | Carbon | Carbon | | | | | DIW/ | 50% | |
| | Expanded | Black | Fiber | | | | PEVA/PEI | 1- | GA in | 35% |
| | Graphite | XC-72R | Panex | Silica | PEI | PEVA | Solution | propanol | Water | HCl |
| Trial | (g) | (g) | 30 (g) | (g) | (%) | (%) | (g) | (ml) | (ml) | (ml) |
| 1 | 10 | 2 | 6 | | 0 | 10 | 15 | 20 | 5 | 0.75 |
| 2 | 14 | 3 | 1 | | 0 | 5 | 40 | | 5 | 0.75 |
| 3 | 13 | 5 | 0 | | 0 | 5 | 30 | 30 | 5 | 0.75 |
| 4 | 13 | 3 | 0 | | 0 | 5 | 40 | 20 | 5 | 0.75 |
| 5 | 20 | 4 | 12 | | 0 | 10 | 24 | 60 | 6 | 1 |
| 6 | 10 | 2 | 6 | | 0 | 10 | 10 | 30 | 3 | 0.5 |
| 7 | 20 | 4 | 12 | | 0 | 10 | 24 | 60 | 6 | 1 |
| 8 | 13 | 3 | | | 0 | 10 | 20 | 45 | 5 | 1 |
| 9 | 14 | 4 | | | 0 | 10 | 20 | 15 | 5 | 0.75 |
| 10 | 10 | 2 | 6 | | 0 | 10 | 20 | 15 | 5 | 0.75 |
| 11 | 14 | 3 | 9 | 1 | 0 | 10 | 30 | 23 | 7 | 1.25 |
| 12 | 14 | 3 | 9 | 1 | 0 | 10 | 30 | 23 | 7 | 1.25 |
| 13 | 24 | 4 | 8 | | 0 | 10 | 30 | 60 | 7 | 1.25 |
| 14 | 24 | 4 | 8 | 0 | 5 | 9.5 | 30 | 60 | 7 | 1.25 |

We tested the electrodes for their ability to remove salt from salt water in a gravity-driven device. 25 to 30% of the salt was removed after filtration. Results with selected electrodes are shown in Table 3.

TABLE 3
Salt Removal with Selected Electrode Compositions

| | | | | | Outlet | |
|---|---|---|---|---|---|---|
| | | Current | | Solution | Con- | Salt |
| | Voltage | Density | NaCl | Conductivity | ductivity | Reduction |
| Trial | (V) | (mA/cm²) | (%) | (μS) | (μS) | (%) |
| 1 | 1.3 | 0.17 | 0.01 | 229 | 197 | 14 |
| 2 | 1.3 | 0.17 | 0.01 | 219 | 201 | 8.2 |
| 3 | 1.3 | 0.69 | 0.01 | 225 | 151 | 32.9 |
| 9 | 1.3 | 0.17 | 0.01 | 206 | 186 | 9.7 |

### EXAMPLE 5

### Variation of Electrode Porosity Using Different Binder Concentrations

The porosity of electrodes was analyzed as a function of PEVA binder concentration. Binder concentrations of 5%, 7.5%, and 10% were used in preparation of the electrodes. The electrodes contained 10% carbon black and 10% carbon fiber. The porosity was tested using the BET (Brunauer, Emmett, and Teller) method to determine electrode properties such as gas uptake, micropore volume (t-plot method), porosity, and pore size distribution via adsorption and desorption isotherms. The results are shown in Table 4. The porosity of the electrode decreased as the amount of binder increased.

TABLE 4
Porosity Analysis

| Composition | 5% Binder | 7.5% Binder | 10% Binder |
|---|---|---|---|
| Total Intrusion Volume (ml/g) | 1.8393 | 1.3900 | 1.0715 |
| Total Pore Area (m²/g) | 14.107 | 23.931 | 23.714 |
| Median Pore Diameter | 1.9805 | 0.6881 | 0.5488 |
| (Volume) (μm) | | | |
| Median Pore Diameter (area) | 0.1116 | 0.0669 | 0.0555 |
| (μm) | | | |
| Average Pore Diameter (4V/A) | 0.5215 | 0.2323 | 0.1807 |
| (μm) | | | |
| Bulk Density at 25 psia (g/ml) | 0.5326 | 0.5368 | 0.6528 |
| Apparent (Skeletal) Density | 1.7390 | 1.7127 | 1.7468 |
| (g/ml) | | | |
| Porosity (%) | 76.1814 | 71.5888 | 65.1779 |
| Surface Resistance (Ω/cm) | 32 | 25 | 22 |

### EXAMPLE 5

### Filtration of Ferric Nitrate

We tested the ability of the filter electrodes to remove iron from a 1M ferric nitrate solution. Fifty ml of a 0.01M ferric nitrate solution and 0.01M lead nitrate solution were filtered through a gravity-driven device, using electrodes with a composition containing 7.5% PEVA, 62.5% exfoliated graphite, 10% carbon black, and 20% carbon fiber. The solution was visually bright yellow prior to filtration, and the filtered solution was light yellow in color, indicating that iron ions had been removed by filtration. 7.7 mg iron was filtered per gram of electrode and 15.4 mg lead was filtered per gram of electrode, as shown in Table 5.

TABLE 5
Filtration Study

| | | | Ion mg/g |
|---|---|---|---|
| | Pre-filtered | Filtered | electrode |
| Iron (mg/L) | 609 | 55 | 7.7 |
| Lead (mg/L) | 2250 | 110 | 15.4 |
| Nitrate (mg/L) NO₃ | 4090 | 350 | 49 |

### EXAMPLE 6

### Filtration Under Pressure

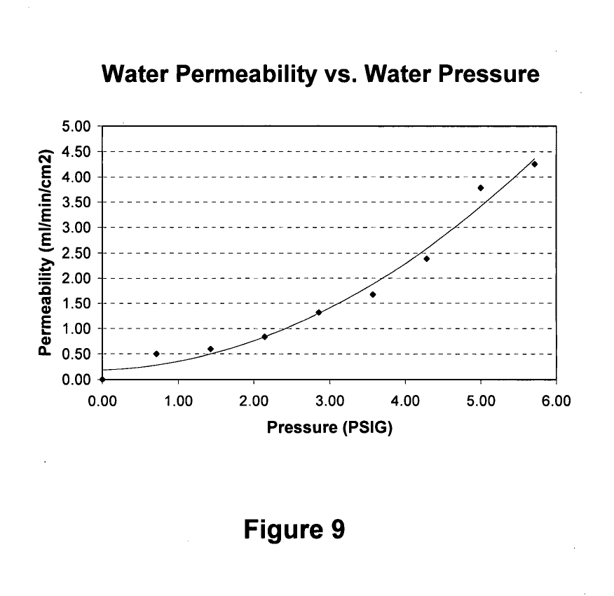

We also tested a three-stage pressure-driven device, depicted schematically in FIG. 5, using electrodes with a composition containing 7.5% PEVA, 62.5% exfoliated graphite, 10% carbon black, and 20% carbon fiber. The device was operated under varying pressure conditions. The flow rate increased versus the flow rate under gravity alone. The flow rate increased as a function of pressure, as shown in Table 6 and FIG. 9.

TABLE 6
Water Flow Rates under Different Pressures

| | Pressure (inch water) | | | | | | | |
|---|---|---|---|---|---|---|---|---|
| | 20 | 40 | 60 | 80 | 100 | 120 | 140 | 160 |
| Flow rate | 0.50 | 0.62 | 0.83 | 1.31 | 1.70 | 2.47 | 3.80 | 4.25 |
| (ml/min/cm²) | | | | | | | | |

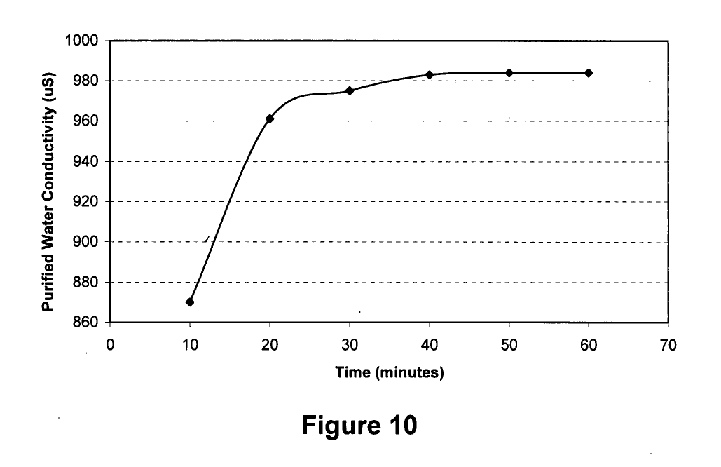

FIG. 10 shows effluent conductivity over time at a pressure of 20 inch H₂O. The electrode area was approximately 12 cm².

### EXAMPLE 7

### Porous Graphite-Based Electrodes with Microchannels

We introduced microchannels into the porous graphite-based electrodes during fabrication, to increase water permeability and ion adsorption. Electrodes were prepared by mixing exfoliated graphite powder with carbon black, metal oxide, and optionally carbon fibers and/or silica. Then, one or more binders, such as PEVA, PVA, and/or PEI were added. The slurry was mixed well. A cross-linking agent was added to the slurry and mixed well. The slurry was cast to a thickness of 0.75 mm. The cast sheet was partially dried at room temperature about 5 to 30 minutes to retain 60 to 80% solvent in the electrode, then punched with pins about 0.3 mm in diameter and about 5 mm apart. The polymeric binder formed a thin, water permeable membrane at each end of a microchannel as it opened to the surface of the electrode (see FIG. 5). The microchannels increase water transport radiance in all directions, and increase the total surface area available for ion adsorption in the porous electrode. The microchannels form saturated zones for ionic adsorption, thus reducing “dead zones” that are difficult for water to enter.

All publications, patents, and patent applications cited herein are hereby incorporated by reference in their entireties for all purposes and to the same extent as if each individual publication, patent, or patent application were specifically and individually indicated to be so incorporated by reference.

Although the foregoing invention has been described in some detail by way of illustration and examples for purposes of clarity of understanding, it will be apparent to those skilled in the art that certain changes and modifications may be practiced without departing from the spirit and scope of the invention. Therefore, the description should not be construed as limiting the scope of the invention, which is delineated by the appended claims.

What is claimed is:

1. A water purification system comprising:
a porous anode electrode and a porous cathode electrode, each of said electrodes comprising graphite, at least one metal oxide, and at least one cross-linked, polarizable polymer comprising ion exchange groups, wherein said porous electrodes comprise microchannels; and
an electrically non-conductive, fluid permeable separator element disposed between said anode electrode and said cathode electrode.

2. A water purification system in accordance with claim 1, wherein said at least one polymer comprises a polymer selected from the group consisting of polyurethane, polyacrylic acid, sulfonated polystyrene, poly(vinyl alcohol), poly(ethylene vinyl alcohol), polyethylene imine, and combinations thereof.

3. A water purification system in accordance with claim 1, wherein said at least one metal oxide is stable in water.

4. A water purification system in accordance with claim 3, wherein said at least one metal oxide comprises a metal oxide selected from the group consisting of TiO₂, Al₂O₃, and mixtures thereof.

5. A water purification system in accordance with claim 1, wherein said polymer is cross-linked with a cross-linking agent selected from the group consisting of glyoxal, formaldehyde, glutaraldehyde, methylene amine, and combinations thereof.

6. A water purification system in accordance with claim 1, wherein said graphite is exfoliated graphite.

7. A water purification system in accordance with claim 6, wherein said exfoliated graphite comprises exfoliated graphite particles having a particle size less than about 50μ in diameter.

8. A water purification system in accordance with claim 1, wherein said anode and cathode electrodes and said separator element are disposed within an electrically nonconductive housing comprising an inlet opening and an outlet opening, wherein said water purification system is adapted such that a water stream to be purified flows from said inlet to said outlet through said anode electrode, said separator, and said cathode electrode.

9. A water purification system in accordance with claim 1, wherein said electrodes are substantially hydrophilic.

10. A water purification system in accordance with claim 9, wherein said electrodes comprise at least one hydrophobic group.

11. A water purification system in accordance with claim 1, wherein said electrodes comprise a current collector embedded within or contacting the edges of said electrodes.

12. A water purification system in accordance with claim 1, wherein said electrically non-conductive, fluid permeable separator element is a perforated plastic sheet comprising an open area of at least about 40% to about 80%.

13. A water purification system in accordance with claim 1, wherein at least one of said electrodes comprises carbon black.

14. A water purification system in accordance with claim 1, wherein said porous electrodes comprise a porosity of at least about 50% to about 80% by volume of said electrodes.

15. An electrode for use in a water purification system, comprising graphite, at least one metal oxide, and at least one cross-linked, polarizable polymer comprising ion exchange groups, and comprising a porosity of at least about 50% by volume of said electrode, wherein electrode comprises microchannels.

16. An electrode in accordance with claim 15, wherein said at least one polymer comprises a polymer selected from the group consisting of polyurethane, polyacrylic acid, sulfonated polystyrene, poly(vinyl alcohol), poly(ethylene vinyl alcohol), polyethylene imine and combinations thereof.

17. An electrode in accordance with claim 15, wherein said graphite is exfoliated graphite comprising exfoliated graphite particles having a particle size less than about 50μ in diameter.

18. An electrode in accordance with claim 15, wherein said polymer is cross-linked with a cross-linking agent selected from the group consisting of glyoxal, formaldehyde, glutaraldehyde, methylene amine, and combinations thereof.

19. An electrode in accordance with claim 15, wherein a current collector is embedded within or contacting the edge of said electrode.

20. An electrode in accordance with claim 15, wherein said electrode is substantially hydrophilic.

21. An electrode in accordance with claim 20, wherein said electrode comprises at least one hydrophobic group.

22. An electrode in accordance with claim 15, further comprising carbon black dispersed substantially uniformly throughout said electrode.

23. An electrode in accordance with claim 15, wherein said at least one metal oxide comprises a metal oxide selected from the group consisting of TiO₂, Al₂O₃, and mixtures thereof.

24. An electrode in accordance with claim 15, wherein said electrode comprises front and back surfaces, wherein said microchannels comprise openings at said front and back electrode surfaces, and wherein said electrode comprises a thin layer polymeric membrane covering the microchannel openings on the front and back surfaces of the electrode.
